(19) United States
(12) Patent Application Publication
(10) Pub. No.: US 2008/0268094 A1
(43) Pub. Date: Oct. 30, 2008

(54) Mixtures of Fatty Acid Glycerides from C1 to C22 to Improve Zootechnical Performances and/or the Health of the Intestine of Animals

(76) Inventor: Fernando Cantini, Firenze (IT)

Correspondence Address: COLLARD & ROE, P.C., 1077 NORTHERN BOULEVARD, ROSLYN, NY, 11576, US

(21) Appl. No.: 11/883,952

(22) PCT Filed: Oct. 13, 2005
(86) PCT No.: PCT/IT2005/000601

§ 371 Date: Aug. 8, 2007

(30) Foreign Application Priority Data
Feb. 14, 2005 (IT) FI2005A000024

(51) Int. Cl. A23K 1/16; A23K 1/18; A23D 9/013; C11C 3/00; A23D 9/02

(52) U.S. Cl. 426/2; 426/601

(57) ABSTRACT

The invention relates to the production and/or use of mixtures of monoglycerides, diglycerides and triglycerides of fatty acids from C₁ to C₂₂ to administer to livestock and pets, in order to improve performances and the health of the intestine. The glycerides are produced by the reaction of glycerol with mixtures of fatty acids from C₁ to C₂₂ or by the reaction of glycerol with mixtures of fatty acids from C₁ to C₂₂ and/or vegetable oils and/or animal fats. In one embodiment, a minimum of 5% and a maximum of 100% of butyric acid is provided.

The present invention relates to the production and/or use of mixtures of monoglycerides, diglycerides and triglycerides of fatty acids from C₁ to C₂₂ to administer to livestock and pets, in order to improve performances and the health of the intestine.

In particular, the invention relates to the production and/or use of mixtures of monoglycerides, diglycerides and triglycerides of fatty acids from C₁ to C₁₂, charged with improving the health of the intestinal tract of animals, and of mixtures of monoglycerides, diglycerides and triglycerides of fatty acids from C₁ to C₂₂, charged with controlling the quantity and quality of depot fat, satisfying specific nutritional requirements of the various animal species in various ages and improving the health of the intestine.

These glycerides are produced by the reaction of glycerol with fatty acids from C₁ to C₂₂ previously mixed together, or by the reaction of glycerol with mixtures of fatty acids from C₁ to C₂₂ and/or with vegetable oils and/or with animal fats.

Other characteristics of the invention are defined in the claims following the present description.

The present invention contributes towards solving two important problems in livestock feeding, namely:

health of the intestinal tract,

control of the quantity and quality of depot fats.

This is obtained through the production and/or use, in animal feeding, of:

mixtures of monoglycerides, diglycerides and triglycerides of short and medium chain fatty acids from C₁ to C₁₂ to improve the health of the intestinal tract;

mixtures of monoglycerides, diglycerides and triglycerides of fatty acids from C₁ to C₂₂ to control the quantity and quality of depot fats and improve the health of the intestinal tract.

With regard to the health of the intestinal tract, recent directives on the subject of food safety provide for a gradual but unequivocal withdrawal of the use of antibiotics, and therefore the development of new products capable of combating pathogenic agents with “natural” mechanisms has become urgent and a priority.

It is useful to specify that for some time now it has been known that butyric acid (C₄:0) is efficacious as nutrient of the intestinal mucosa, as stimulator of intestinal trophism in terms of renewal of basal cells and increase in the density and length of villi, as antibacterial/bacteriostatic agent against pathogenic microorganisms, including clostridium acetobutylicum, Escherichia coli, streptococcus cremoris, salmonella sp, brachyspira hyodysenteriae etc., and as modulator of the intestinal flora as it promotes the development of “useful” microorganisms such as lactobacilli.

In nature, butyric acid is found in the milk of cows, sows and other species. Moreover, butyric acid is commonly produced in the intestine subsequent to digestive-metabolic degradation of fibers and carbohydrates.

The beneficial effects of butyric acid (from its bacteriostatic effect to its ameliorative effect on zootechnical yield as stimulator of the growth of intestinal villi) are widely documented in the scientific literature with reference to various livestock species (poultry, pigs, rabbits, ruminants) and the zootechnical industry has for some time been involved in implementing methods that allow sources of butyric acid to be added to the diets of animals at costs that permit their use at efficacious doses in rearing of livestock.

In practice, there are in fact numerous limits to the use of products based on butyric acid. One of these is represented by the extremely unpleasant and persistent odor which also remains in some products in which it is contained (i.e. in the salts of butyric acid such as calcium or sodium butyrate).

Another limitation is represented by the high costs of products which although containing butyric acid are odorless, but generally also very expensive, such as microencapsulated products.

The unpleasant and persistent odor of butyric acid are caused by the extremely high volatility of this fatty acid. In the new glycerides forming the object of the present invention the volatility of the butyric acid is drastically limited by increasing the molecular weight due to combination of said butyric acid with glycerol. The new glycerides containing butyric acid have a slight odor, not unpleasant and not persistent. Moreover, the production process employed to produce the new glycerides does not require forms of encapsulation and does not require aromatization, thereby making it possible to obtain a final product at limited costs.

With regard to elimination of the odor of butyric acid and limiting production costs, the glycerides to which the present invention refer solve the problem completely.

With regard to bacteriostatic efficacy, the glycerides, to which the present invention refers, represent an interesting solution to another problem which arises when the butyric acid requires to be carried, in its undissociated form, to intestinal tracts where it is required to perform its bacteriostatic function and stimulate the trophism of basal cells.

With the new glycerides the butyric acid it is, in fact, administered in the form of glyceride, or as fatty acid bound to glyceride.

The glycerol-organic acid bond is not influenced by the pH of the stomach (gastric by-pass) and the glycerides reach the intestine integral, where the gradual process to release the fatty acids through the action of lipases takes place. The fatty acids, in this case butyric acid, is released by enzymatic attack, in its undissociated form, as the glyceride advances in the intestine, exerting its efficacy through time and in the various intestinal tracts (slow release effect). The decomposition process of the glycerides can in this case be compared to the process to which the glycerides forming the lipid fraction of the milk of cows, sows and other species are subjected.

Other volatile fatty acids from C₁ to C₁₂ and contained, in nature, in foods (such as grapes, honey, wine, milk, butter, cheese, etc) also perform useful and selective antibacterial/bacteriostatic actions against strains of intestinal pathogens (such as E. coli, Oocysts, Clostridium perfrigens, Salmonella enteritidis etc.), and can therefore contribute towards the health of the intestinal tract. Nonetheless, due to their volatile nature, these organic acids have problems of handling and administration common to those of butyric acid: they release strong and unpleasant odors, tend to evaporate if added as is (loose) to the feed, require carrier forms that guarantee their integrity during passage through the stomach (gastric by-pass), and release, in undissociated form, in the various tracts of the intestine. As in the case of butyric acid, by increasing the molecular weight, bonding with glycerol eliminates the problems of odor and volatility, and moreover, as it is not influenced by the pH of the stomach, it guarantees gastric by-pass and allows slow release of the undissociated fatty acid in the various intestinal tracts.

The mixtures of glycerides forming the subject of the present invention offer important advantages not only for their efficacy in carrying, in the various intestinal tracts, specific fatty acids important for antibacterial action, health and trophism of the intestine, but also for their specifically nutritional value. In particular, the mixtures of fatty acid glycerides from C₁ to C₂₂ forming the object of the present invention have three aspects worthy of notice:
A) the glycerides in question are composed of monoglycerides, diglycerides and triglycerides in proportions which exert an emulsioning action suitable to promote absorption of the fatty acids contained in glycerides and also of those other fatty acids contained in the lipid fraction of the diet;
B) as the fatty acids in the monoglycerides and in the diglycerides in question are prevalently (over 80%) in position 1 and 3 in the molecule, this peculiarity means that these monoglycerides and diglycerides (once absorbed) have difficulty in being reesterified into triglycerides and are therefore used by the animal prevalently for energy purposes; consequently, it is possible to program the new glycerides as a function of the greater or lesser quantity of depot fats required, predetermining the percentage of monoglycerides and diglycerides of the mixtures by dosing the glycerol in the production process;
C) in the glycerides containing butyric acid noteworthy synergy is always obtained between bacteriostatic efficacy and nutritional efficacy.

According to the invention, the percentages of monoglycerides, diglycerides and triglycerides of the fatty acids can vary in the following proportions:

in mixtures with fatty acids from C₁ to C₁₂

| | |
|---|---|
| monoglycerides | 0%-86% |
| diglycerides | 0%-86% |
| triglycerides | 0%-100% |

in mixtures with fatty acids from C₄ to C₂₂

| | |
|---|---|
| monoglycerides | 7%-86% |
| diglycerides | 7%-86% |
| triglycerides | 7%-86% |

By way of example, a mixture of glycerides of butyric acid can be composed of:

| | |
|---|---|
| monoglycerides of butyric acid = | 20%-25% |
| diglycerides of butyric acid = | 47%-53% |
| triglycerides of butyric acid = | 25%-30% |

A mixture of this type has proved particularly efficacious in poultry in stimulating the growth of intestinal villi (with consequent improvement in the absorption of nutrients and in obtaining a high antibacterial/bacteriostatic effect).

See Reports:
Short Title: BUTYRIC ACID ON PERFORMANCE AND CARCASS YIELD Scientific Section: METABOLISM AND NUTRITION—Effect of Butyric Acid on the Performance and Carcass Yield of Broiler Chickens—S. Leeson Department of Animal & Poultry Science, University of Guelph, ON, Canada NIG 2W1; H. Namkung, M. Antongiovanni Department of Animal Science University of Florence (Italy), and F. H. Lee, Vetech Laboratories Inc. 131 Malcolm Road, Guelph, ON, Canada N1K 1AB.
Response of Broiler Chickens to Glycerides of Butyric Acid (GBA) Department of Animal Science University of Florence (Italy) Mauro Antongiovanni, Arianna Buccioni, Francesco Petacchi—2004.

It has been ascertained that use of butyric acid in feed for poultry administered to the animals in the aforesaid chemical forms boosts the efficacy of vaccination against coccidiosis.

In particular, in animals subjected to experimental infection with Oocysts and Clostridium Perfrigens it has been shown that the growth of animals, to which butyric acid was administered in association with the vaccine against coccidiosis, was superior to those vaccinated (and infected) without the addition of butyric acid.

See reports:
“Effect of butyric acid on the performance and carcass quality of broiler chickens” experiment 2—Prof. Leeson of the University of Guelph—Canada—2004.
“Preliminary results of a growth trial of broiler chickens with short chain fatty acids replacing the antibiotic avilamycin” Prof. M. Antongiovanni—University of Florence—2005.

The use in animal feed of glycerides as above containing from a minimum of 5% to a maximum of 100% of butyric acid, makes it possible to modulate the final quantity of butyric acid in the diet as a function of the total percentage of lipids added and of the specific nutritional requirements, or to boost the immune response against intestinal pathogenic agents (salmonella, E. coli, etc.) of the various species of farm animals.

The glycerides in question—in particular from C₁ to C₁₂—can also be utilized carried in the drinking water destined for the animals.

This makes it possible to obtain variation of the daily doses to be administered as a function of the specific and contingent requirements and also facilitates direct use by farm workers. Administration of the glycerides in question in the drinking water is made possible by the high monoglyceride and diglyceride content; in fact, monoglycerides and diglycerides are highly “polar” compounds able to make the glycerides in which they are contained easily water-dispersible.

Some examples of the use of products based on fatty acid glycerides are given hereunder.

The use of glycerides containing both butyric acid and short and medium chain fatty acids from C₁ to C₁₂ in animal feed makes it possible to obtain, in addition to the antibacterial/bacteriostatic effect, an important nutritional value especially for young animals: in fact, fatty acids from C₁ to C₁₂ represent a source of energy which can be assimilated even if there is a scarcity of biliary salts (typical in young animals). The percentage of butyric acid in these mixtures of glycerides can vary from 5% to 100%.

The use of mixtures of butyric acid and C₁₈ unsaturated fatty acids in the form of glycerides in animal feed has shown to have high digestibility, a high energy value and numerous and different actions. This can be found particularly in the case of butyric acid and oleic acid (C₁₈:1) and/or linoleic acid (C₁₈:2).

In fact, the glycerides structured as indicated above allow butyric acid (which performs antibacterial/bacteriostatic functions, functions of modulation of the intestinal flora and stimulation of the growth of intestinal villi) to be administered simultaneously to oleic acid (important for its high digestibility and beneficial effects on the metabolism of lipids) and/or to linoleic acid, an essential fatty acid not synthesized by the organism but indispensable for its functions, in particular in young animals.

The percentage of butyric acid in these mixtures normally varies from 2% to 15%, the percentage of oleic acid from 40% to 70% and the percentage of linoleic acid from 10% to 60%.

The use in animal feed of mixtures of butyric acid and saturated fatty acids C₁₆-C₁₈ in the form of glycerides offers numerous advantages: the glycerides thus structured allow butyric acid (which performs antibacterial/bacteriostatic functions, functions of modulation of the intestinal flora and stimulation of the growth of intestinal villi) to be administered simultaneously to palmitic acid and to stearic acid. In this way, in finishing, in addition to covering specific physiological requirements, the subcutaneous fat of the animal destined for slaughter is given consistency and oxidation stability.

The percentage of butyric acid in these mixtures normally varies from 2% to 20%, the percentage of palmitic acid from 10% to 50% and the percentage of stearic acid from 2% to 70%.

The above description can vary within the scope of the claims hereunder.

1-23. (canceled)

24. Additives for animal food comprising a mixture of glycerides of fatty acids C₄-C₂₂ wherein the percentage of said glycerides can vary in the following proportions:

| | |
|---|---|
| monoglycerides | 7%-86% |
| diglycerides | 7%-86% |
| triglycerides | 7%-86% |

25. Additives according to claim 24, wherein the fatty acids in the monoglycerides and in the diglycerides are over 80% in position 1 and 3 of the molecule.

26. Additives according to claim 25, wherein said glycerides are glycerides of butyric acid.

27. Additives according to claim 26, wherein said mixture of glycerides of butyric acid is composed of:

| | |
|---|---|
| monoglycerides of butyric acid = | 20%-25% |
| diglycerides of butyric acid = | 47%-53% |
| triglycerides of butyric acid = | 25%-30% |

28. Additives for animal food comprising a mixture of glycerides of fatty acids C₁-C₁₂ containing from a minimum of 5% to a maximum of 100% of butyric acid.

29. Additives according to claim 28, wherein said glycerides are glycerides of butyric acid.

30. Additives according to claim 29, wherein said mixture of glycerides of butyric acid is composed of:

| | |
|---|---|
| monoglycerides of butyric acid = | 20%-25% |
| diglycerides of butyric acid = | 47%-53% |
| triglycerides of butyric acid = | 25%-30%. |

31. Additives for animal food wherein the glycerides are a mixture of butyric acid and C₁₈ unsaturated fatty acids glycerides.

32. Additives according to claim 31, wherein the percentage of butyric acid varies from 2%-15%, the percentage of oleic acid from 40%-70% and the percentage of linoleic acid from 10%-60%.

33. Additives for animal food comprising a mixture of glycerides of butyric acid and saturated fatty acids C₁₆-C₁₈ wherein the percentage of butyric acid varies from 2%-20%, the percentage of palmitic acid from 10%-50% and the percentage of stearic acid from 2%-70%.

34. Process for producing the additives according to claim 24, by reaction of glycerol with fatty acids previously mixed together possibly in the presence of vegetable oils and animal fats.

35. Process for producing the additives according to claim 24, by reaction of glycerol with mixtures of vegetable oils or animal fats.

36. Method for feeding poultry wherein additives according to claim 30 are used.

37. Method according to claim 36, wherein the fatty acid present is only butyric acid.

38. Method for feeding animals wherein the additives according to claim 24, are in drinking water destined for the animals.

39. Method for treating coccidiosis wherein additives according to claim 24, are used in association with vaccine against coccidiosis.
